(19) United States
(12) Patent Application Publication
(10) Pub. No.: US 2026/0310373 A1
(43) Pub. Date: Oct. 8, 2026

(54) QL With An Experience Replay Buffer And Minimal Error Term Selection

(71) Applicant: Sandisk Technologies, Inc., Milpitas, CA (US)

(72) Inventors: Rami ROM, Tel Aviv (IL); Omer FAINZILBER, Herzeliya (IL); Ran ZAMIR, Ramat Gan (IL)

(73) Assignee: Sandisk Technologies, Inc., Milpitas, CA (US)

(21) Appl. No.: 19/097,164

(22) Filed: Apr. 1, 2025

(51) Int. Cl. G06F 3/06; G06N 20/00

(52) U.S. Cl. CPC G06F 3/0655; G06F 3/0604; G06F 3/0679; G06N 20/00

(57) ABSTRACT

Both a Q table and a B table are created and used to improve QL system performance, power consumption, and the cost associated with a data storage device. The Q table and the B table have a plurality of states with each state having a plurality of actions. The states are identical for the Q table and the B table, as are the actions. The Q table focuses on a maximum value while the B table focuses on a minimum value.

### BACKGROUND OF THE DISCLOSURE

### Field of the Disclosure

Embodiments of the present disclosure generally relate to data storage devices, such as solid state drives (SSDs).

### Description of the Related Art

Data storage devices, such as SSDs, may be used in computers in applications where relatively low latency and high capacity storage are desired. For example, SSDs may exhibit lower latency, particularly for random reads and writes, than hard disk drives (HDDs). Typically, a controller of the SSD receives a command to read or write data from a host device to a memory device. The data is read and written to one or more blocks in the memory device. Each of the one or more blocks comprises one or more planes, where each of the one or more planes comprises one or more pages. Data storage devices may be utilized for reinforcement learning (RL) applications, such as to store and perform calculations for the RL applications.

RL is an area of machine learning concerned with how software agents ought to take actions in an environment in order to maximize the notion of cumulative reward. RL may be utilized in machine learning (ML) and artificial intelligence (AI) applications. RL has achieved super-human performance in strategy board games, such as Go, and in Atari games, such as Video Pinball and Atlantis. RL is a promising area of machine learning for edge applications, such as autonomous power management in mobile devices. For example, the device, such as the mobile device, may be required to respond to a RL decision and update the device protocols based on the RL decision. The RL algorithms, in many instances, require large amounts of memory and large amounts of power consumption due to the amount of memory utilized and the computational power required. Furthermore, the RL algorithms may be implemented as software and completed by the CPU or the GPU.

Therefore, what is needed is an improved method of operating a data storage device, with respect to RL, that improves system performance, power consumption, and the cost associated with the data storage device.

### SUMMARY OF THE DISCLOSURE

Both a Q table and a B table can be created used to improve system performance, power consumption, and the cost associated with a data storage device. The Q table and the B table have a plurality of states with each state having a plurality of actions. The states are identical for the Q table and the B table, as are the actions. The Q table focuses on a maximum value while the B table focuses on a minimum value. A single state is stored on a single word line of a memory device. The word line contains the state of not only the Q table, but the B table as well. The state is the same state for the Q table and the B table. Thus, when sensing the word line, all actions are obtained for both the Q table and the B table for the specific state.

In one embodiment, a data storage device comprises: a non-volatile memory (NVM) device; and a controller coupled to the NVM device, wherein the controller is configured to: receive Q table and B table data from the NVM device; execute a modified Q-learning model training algorithm to create updated Q table and B table data; and write the updated Q and B tables data in the NVM device, wherein: all actions associated with a state of the Q table and B table are stored on the same word line of the NVM device such that reading a word line senses all action values associated with a Q table and B table state.

In another embodiment, a QL training method comprises: reading Q table and B table data from an NVM device; running a plurality of training episodes, in each episode, selecting in each state an action and accordingly the next state according to the maximal Q table value, the minimal B table value, or a random selection with predefined probabilities; and updating the Q table and B table data in the NVM device, wherein all actions associated with a state of the Q table and B table needed for maximum or minimum calculations are stored on the same word line of the NVM device.

In another embodiment, a data storage device comprises: means to store data; and a controller coupled to the means to store data, wherein the controller is configured to: generate a Q table and a B table, wherein each of the Q table and B table comprises a plurality of states, wherein all actions associated with a state of the Q table and B table are stored on a single word line; sense the single word line of the means to store data, wherein sensing a single word line senses all the data for a single state of the Q table and B table; perform a max argument calculation for the Q table for the state of the single word line; perform a min argument calculation for the B table for the state of the single word line; update the Q table and B table with results of the max and min argument calculations; and advance to the next state.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a data storage system, according to one embodiment.

FIGS. 2A-2B are an illustration of a type of reinforcement learning, according to one embodiment.

FIG. 3 is a schematic illustration of a Q table arrangement on a page of the non-volatile storage unit, according to one embodiment.

FIGS. 4A-4B are schematic illustration of one or more Q tables arranged on a word line, according to various embodiments.

FIGS. 5A-5B are schematic block diagrams illustrating a data storage system architectures, according to various embodiments.

FIG. 6 illustrates a method for performing the reinforcement learning calculations and updating the one or more Q tables of the non-volatile storage unit, according to one embodiment.

FIG. 7 is a schematic illustration of a Q table and B table arrangement on a page of a non-volatile storage unit, according to one embodiment.

FIG. 8 is a schematic illustration of the QL taxi driver problem.

FIGS. 9A and 9B are graphs illustrating results of the taxi driver problem of FIG. 8.

FIG. 10 is a graph illustrating the plane edge versus steps for the taxi driver problem of FIG. 8.

FIGS. 11A and 11B are graphs illustrating converged values of the taxi driver problem of FIG. 8.

FIG. 12 is a flowchart illustrating a method for performing the reinforcement learning calculations and updating the B table according to one embodiment.

FIG. 13 is a flowchart illustrating a method for creating and sensing data from a memory device.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Both a Q table and a B table can be created used to improve system performance, power consumption, and the cost associated with a data storage device. The Q table and the B table have a plurality of states with each state having a plurality of actions. The states are identical for the Q table and the B table, as are the actions. The Q table focuses on a maximum value while the B table focuses on a minimum value. A single state, or a plurality of states, is stored on a single word line of a memory device. The word line contains the state of not only the Q table, but the B table as well. The state is the same state for the Q table and the B table. Thus, when sensing the word line, all actions are obtained for both the Q table and the B table for the specific state or the plurality of states.

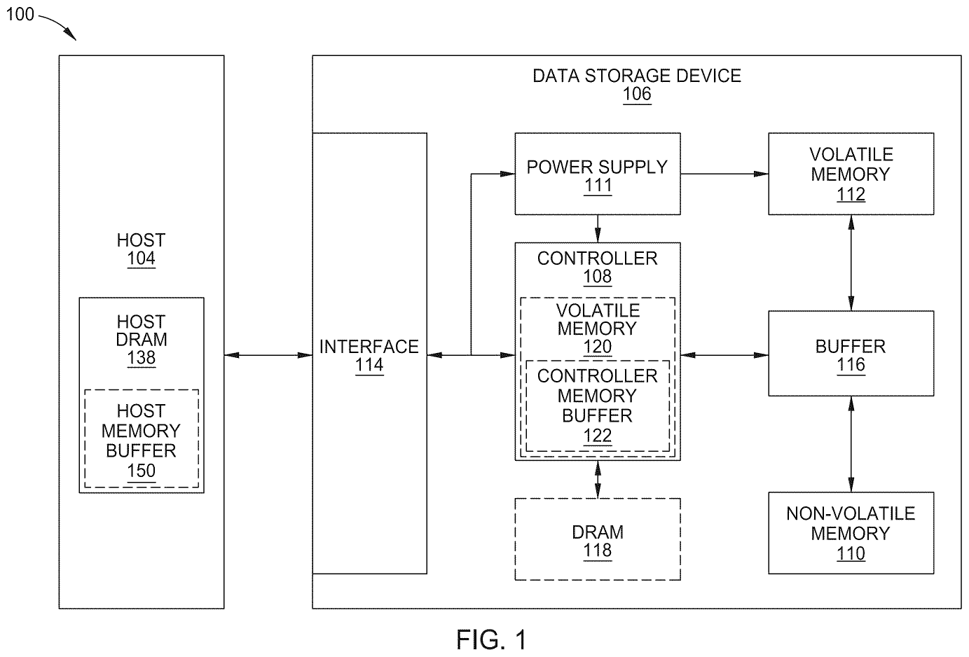

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

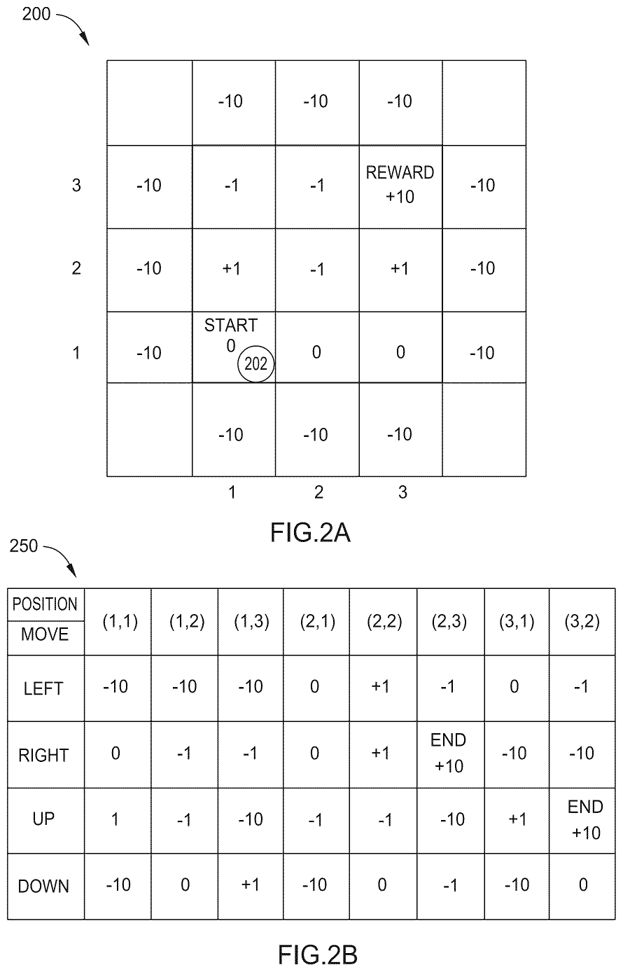

FIGS. 2A-2B are an illustration of a type of reinforcement learning, according to one embodiment. Reinforcement learning (RL) determines a balance between exploration and exploitation. Exploration is the gathering of information that may result in better future decisions and exploitation is the usage of current information (i.e., prior knowledge and the information gathered from exploration) to determine the best decision. Reinforcement learning may be modeled by the Markov decision process, where a number of environments exists for a number of states. Each of the states includes set of actions that the agent may perform. FIGS. 2A-2B illustrate a reinforcement learning algorithm that seeks to find the best action to take given the current state. Q-learning may be considered an off policy reinforcement learning algorithm because the Q-learning function learns from performing actions outside the current policy, such as performing a random action, instead of taking the current best action. In one embodiment, the reinforcement learning algorithm is Q-learning, where the “Q” in Q-learning stands for quality. Quality, in the current context, represents how useful a given action is for the cumulative future reward (including the immediate future reward). The Q-learning algorithms seek to learn a policy that maximizes the total reward.

FIG. 2A illustrates a board 200, where the board 200 includes a 3×3 set (i.e., 9 tiles) of valid tiles and an additional 12 tiles of invalid tiles. Each of the tiles of the board 200 includes a point value, where the 12 invalid tiles each has a point value of −10 and each of the 9 valid tiles has a point value of −1, 0, 1, or 10. FIG. 2B illustrates a table 250 illustrating the potential point value of moving a game chip 202 from a position of the board 200 to an adjacent position on the board 200. However, for the initial environment, the table 250 is empty. Each time the agent performs an action (e.g., moving the game chip 202 to an adjacent tile), the table 250 is filled with the relevant information (i.e., the expected cumulative future reward for taking the action). The starting position of the game is position (1,1) and the goal is to reach position (3,3), while maximizing the points gained. Furthermore, when moving to an invalid tile, the points associated with the invalid tile are assigned and the agent returns to the previous tile.

When the table 250 is initialized, the table 250 values are set according to prior knowledge. If no such knowledge is present (e.g., a first iteration of the game) the table 250 values may be set to zero. After each action occurs, the Q-values are updated in the table 250. During the start of the initial environment, the agent performs a random action, where the random action may be characterized as an exploration action. For example, the agent takes a first step from the starting position (1,1), where the first step moves the chip 202 to an invalid tile with a point value of −10. The corresponding entry in the table 250 is filled with the point value of −10 and the chip 202 returns to the previous position, position (1,1). Each time the chip 202 is moved to a new location, the cumulative points are added. For example, when the chip is moved from position (1,1) to (1,2) to (2,2), the cumulative points is calculated as 1+(−1)=0. When the table 250 fills up with updated values after multiple iterations (i.e., environments), the Q-learning algorithm begins to determine the best set of actions to achieve the largest cumulative ending point value.

The Q-learning algorithm may be calculated by the following equation:

$$Q ( {s}_{t} , {a}_{t} ) ← Q ( {s}_{t} , {a}_{t} ) + α [ {r}_{t + 1} + γ arg max Q ( {s}_{t + 1} , a ) - Q ( {s}_{t} , {a}_{t} ) ]$$

where s is the current state, where a is the current action, where Q(s,a) is the max Q table value for all current states and actions, where r is the reward for the current action for the current state, and where γ is a discount factor. For example, when the table 250 is partially or completely filled with updated Q-values, the algorithm may determine the direction of the step that the agent should take in order to maximize the cumulative future reward (i.e., max argument calculation). In one embodiment, maximizing the current reward takes into account the cumulative reward, such as when γ greater than zero. In another embodiment, maximizing the current reward is only concerned with the current reward gain, such as when γ equals zero. After completing the Q-learning algorithm for a first state, the controller may advance compute the results for a second state using the Q-learning algorithm.

Furthermore, the Q-learning algorithm may be employed in a double Q-learning algorithm, where the double Q-learning algorithm requires less training than the Q-learning algorithm. For example, the double Q-learning algorithm utilizes two Q tables to determine the optimal action. The following equations illustrate updating a first Q value function, Q^{A}, and a second Q value function, Q^{B}.

Choose (e.g., random) either UPDATE(A) or UPDATE(B)
if UPDATE (A) then
Define a* = argmax ₐQ^{A}(s',a)
QA(s,a) + Q?(s,a)+a(s,a)[r+yQP(s', a*)-Q^{A}(s, a)]
else if UPDATE(B) then
Define b* = argmax ₐQ^{B}(s', a)
Q^{B} (s, a) ← Q^{B}(s, a) + α(s, a)[r + yQ^{A}(s', a*)-Q^{B}(s, a)]

where a* is the optimal action to be taken in the next step according to the first or second Q tables (Q^{A} or Q^{B}), where a is the action chosen at the current step, where s is the current state, where s′ is the next state, where r is the immediate reward received in the current step, where γ is a discount factor, and where α(s,a) is a step size for the current state and the current action.

By utilizing the two Q value functions Q^{A} and Q^{B} concurrently, each Q value function receives an update from the other Q value function for the next state. For example, the update of Q^{A} comprises finding an action a* that maximizes Q^{A} for the next state (i.e., Q(s′,a*)=argmax Q(s′,a)). The resulting a* value is then utilized to calculate the value of Q^{B}(s′,a*) in order to update Q^{A}(s,a). Furthermore, after completing the action for a first state, the controller may advance to a second state of each of the Q tables.

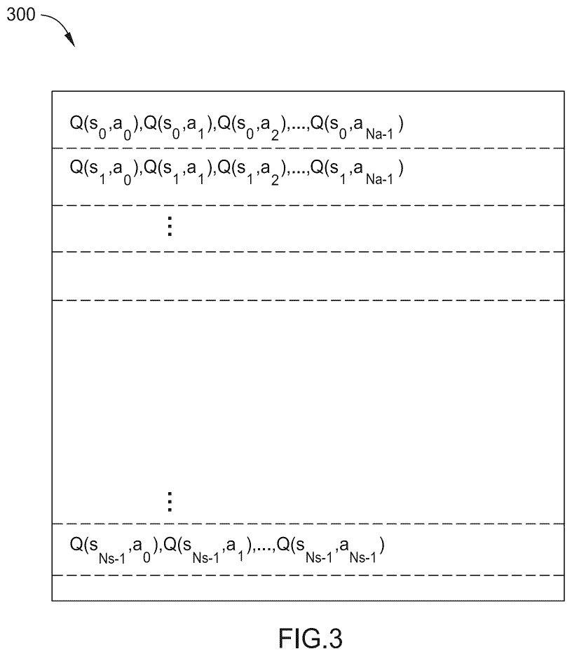

FIG. 3 is a schematic illustration of a Q table arrangement on a page 300 of the non-volatile storage unit, according to one embodiment. The Q table is a 2-dimensional table comprising values of Q(s,a) for each state and action pair. Furthermore, the one or more Q tables may store a size, a location, and a resolution of each entry. In some embodiments, the Q table may require large amounts of memory to store the data associated with each state and action pair. Each line of the page 300 may be a word line, such that a first word line comprises Q(s₀,a₀), Q(s₀,a₁), Q(s₀,a₂), and so-forth. Furthermore, Na represents the number of actions and Ns represents the number of states. By arranging the one or more actions for a state, such as a first state, along a word line, all the data for the first state may be received by sensing the first word line. Furthermore, the data of the Q table may be aligned to each memory location size of about 4 KB or to each page unit.

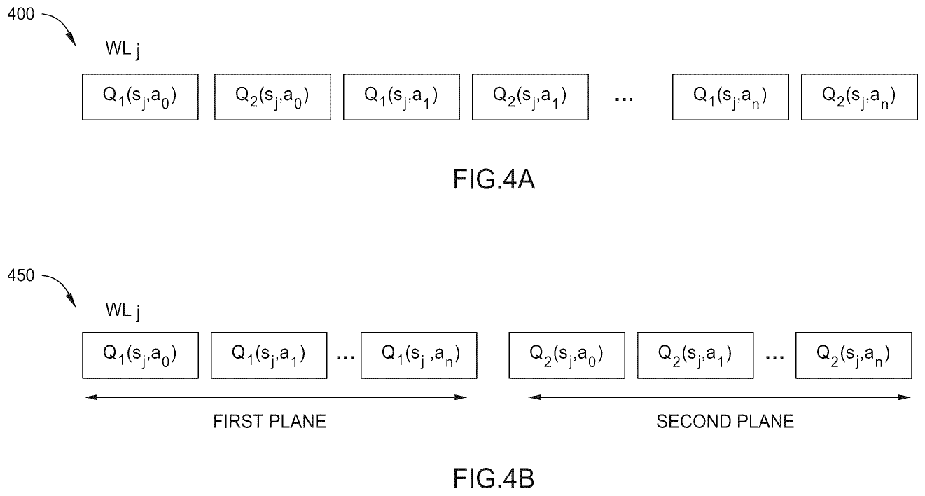

FIG. 4A is a schematic illustration of one or more Q tables arranged on a word line, according to one embodiment. In FIG. 4A, a word line (WL) j comprises a first Q table, Q₁(s,a), and a second Q table, Q₂(s,a). The first Q table and the second Q table are alternating on the WL j, where j represents a state, such as the first state. The WL j is located on a single plane, such as a first plane of a first die. Because both the first and the second Q tables are arranged on the WL j, sensing the WL j retrieves all the data on the word line, such that the first and the second Q tables are read. For a NVM page size of about 16 KB, a plurality of Q value entries (i.e., Q₁(s_{N},a_{M}) and Q₂(s_{N},a_{M})) may be programmed to the NVM page, such as the page 300 of FIG. 3. Each of the entries on the WL j may be related to the different possible actions that may be selected in the state j.

FIG. 4B is a schematic illustration of one or more Q tables arranged on a word line, according to another embodiment. In FIG. 4B, a word line (WL) j comprises a first Q table, Q₁(s,a), and a second Q table, Q₂(s,a). The first Q table and the second Q table located on different planes of the WL j, where j represents a state, such as the first state. The first Q table is located on a first plane and the second Q table is located on a second plane. However, since the first and the second Q tables are on the same word line, WL j, sensing the WL j retrieves all the data on the word line from both the first plane and the second plane. For a NVM page size of about 16 KB, a plurality of Q value entries (i.e., Q₁(s_{N},a_{M}) and Q₂(s_{N},a_{M})) may be programmed to the NVM page, such as the page 300 of FIG. 3. Each of the entries on the WL j may be related to the different possible actions that may be selected in the state j.

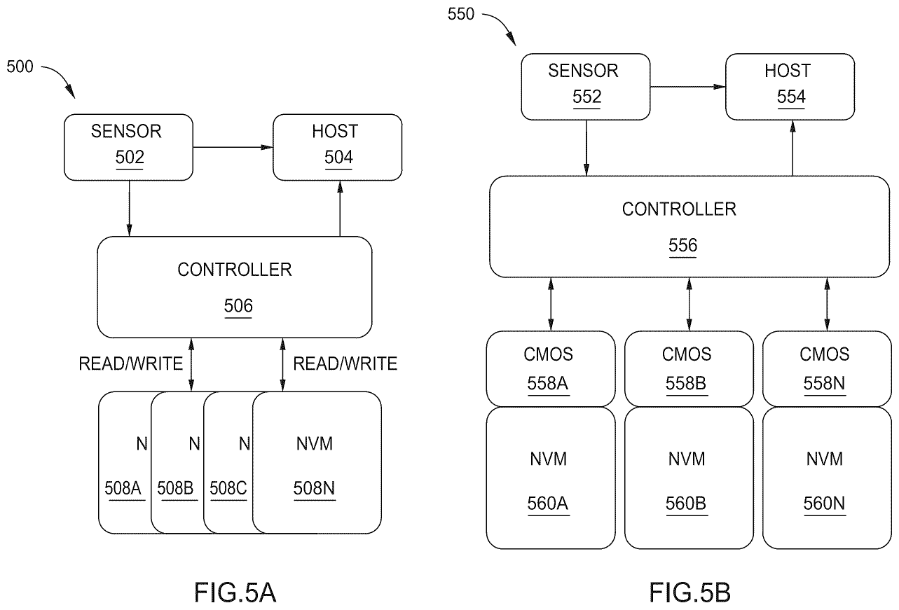

In the description herein, the data storage system architectures 500, 550 of FIGS. 5A and 5B are not intended to be limiting, but to provide an example of possible embodiments. For example, in the data storage system architectures 500, 550, the sensors 502 may be coupled to the host 504 instead of the controller 506 and the sensor 552 may be coupled to the host 554 instead of the controller 556. When the sensor 502, 552 is coupled to the host 504, 554 instead of the controller 506, 556, the host 504, 554 passes the current state information to the controller 506, 556. However, in the embodiments described in FIGS. 5A and 5B, the sensor 502, 552 is coupled to the controller 506, 556. Thus, the sensor 502, 552 provides the controller 506, 556 with the current state information. Furthermore, the plurality of NVMs be referenced by a common number herein, for exemplary purposes. For example, the plurality of NVMs 508A-508N may be collectively referred to as the NVMs 508.

FIG. 5A is a schematic block diagram illustrating a data storage system architecture 500, according to one embodiment. The data storage system architecture 500 includes a sensor 502, a host 504, a controller 506, and a plurality of NVMs 508A-508N. The controller 506 and the NVMs 508 form a data storage device, such as the data storage device 106 of FIG. 1. The sensor 502 provides the controller 506 with the current environment, where the controller 506 performs calculations for each state and corresponding action in order to achieve the maximum future cumulative reward for the current state in the current environment. As shown in FIG. 5A, the sensor 502 may be connected to either the host 504, the controller 506 or both.

The controller 506 retrieves the expected future cumulative reward associated with the current state, where the current state is retrieved from the sensor, from one or more Q tables stored in a relevant location of the one or more NVMs 508A-508N. Each of the one or more Q tables may be arranged on a page of the one or more NVMs 508-508N, where each word line of the page is associated with one or more actions of one state, as described in FIG. 3. Because the calculations are performed in the controller 506, the relevant data entries may be stored in the volatile memory of the controller 506. After the controller 506 completes the calculations, such as the calculations described in FIG. 2, the respective Q table in the one or more NVMs 508A-508N is updated with the updated values from the calculations performed. The controller 506 then provides the host 504 with the action that may result in the max future reward. The controller 506 then advances to the next state, such that the sensor 502 provides the controller 506 with new state of the environment. For example, in the game depicted in FIG. 2, a first state may describe when the game chip 202 is in position (1,1) and a second state may describe when the game chip 202 is in position (1,2).

FIG. 5B is a schematic block diagram illustrating a data storage system architecture 550, according to one embodiment. The data storage system architecture 550 includes a sensor 552, a host 554, a controller 556, a plurality of CMOS logics 558A-558N, where each of the plurality of CMOS logics 558A-558N are coupled to a respective NVM of the plurality of NVMs 560A-560N. The CMOS logics 558A-558N represent control logic that is integrated with the respective NVM 560A-560N, such that some functions previously performed by the controller 556 may be performed by the CMOS logic 558. In one embodiment, the CMOS logic 558A-558N is CMOS by the Array. In another embodiment, the CMOS logic 558A-558N is CMOS under the Array (CuA). In yet another embodiment, the CMOS logic 558A-558N is CMOS bounded Array (CbA). The CMOS logic 558 is capable of performing at least the basic operations of summation, multiplication, argmax, and updating of the one or more Q tables stored in the NVMs 560. The sensor 552 provides the controller 556 with variables that define the current environment. As shown in FIG. 5B, the sensor 552 may be connected to either the host 554, the controller 556 or both.

The controller 556 passes the information to the relevant CMOS logic 558A-558N, such that the CMOS logic performs the basic operations (e.g., summation, multiplication, argmax, and updating of the one or more Q tables). Each of the basic operations may be the calculations described in FIG. 2. Because the CMOS logic may perform the previously mentioned operations for a large number of states in parallel, such as about 4,000 cells per die per plane, the data may be manipulated in the NVM, such that transferring the NVM data to the controller 556 is unnecessary. The CMOS logic 558 updates the one or more Q tables in the NVM 560 directly, with the relevant updated data.

Because the calculations are performed by the CMOS 558A-558N, where the CMOS 558A-558N is coupled to the relevant NVM 560A-560N, the calculations and the update of the data in the NVM 560A-560N may be quicker than transferring the data to a volatile memory location in the controller 556, performing the Q value calculations, and updating the NVM 560A-560N with the updated data. The controller 556 provides the host 504 with the action that may result in the max future cumulative reward based on the calculations performed by the CMOS 558A-558N. The controller 556 then advances to the next state, such that the sensor 502 provides the controller 556 with a new state of the environment. For example, in FIG. 2, a first state may describe when the game chip 202 is in position (1,1) and a second state may describe when the game chip 202 has moved from position (1,1) to position (1,2).

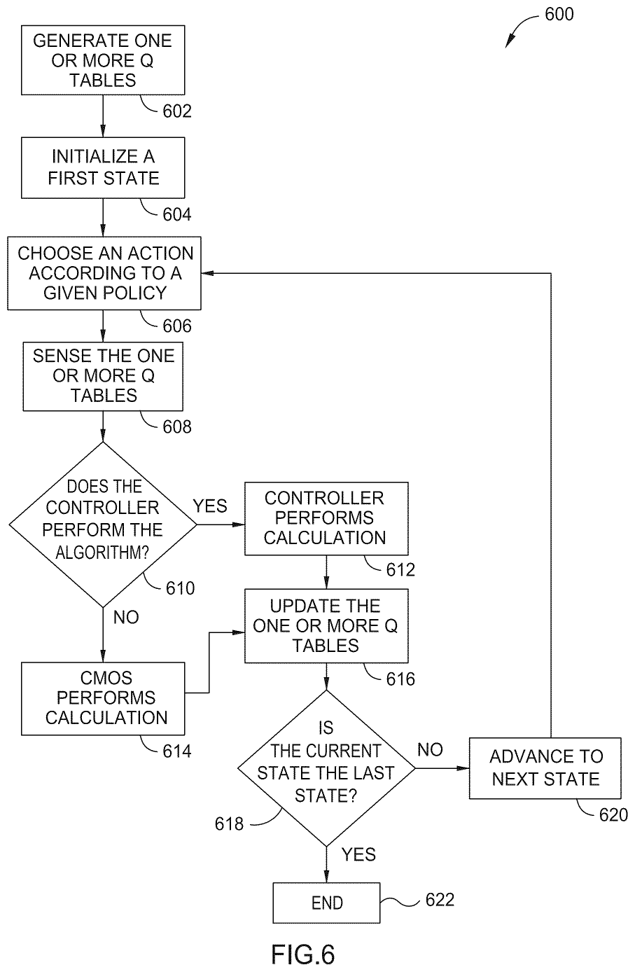

FIG. 6 is a method 600 for performing the reinforcement learning calculations and updating the one or more Q tables of the non-volatile storage unit, according to one embodiment. At block 602, the controller, such as the controller 506 of FIG. 5A, or the CMOS array, such as the CMOS 558A-558N described in FIG. 5B, generates one or more Q tables, where each of the one or more Q tables includes one or more states and one or more actions for the one or more states. The one or more Q tables may have a two dimensional structure that includes a size, a location, and a resolution of each entry.

At block 604, the controller or the CMOS array initializes a first state of the one or more Q-tables after receiving data from a sensor, such as the sensor 502, 552 of FIGS. 5A-5B, for an environment. At block 606, the controller or the CMOS array chooses an action according to a given policy. At block 608, the one or more Q tables stored in the NVM are sensed. Because each state of the one or more Q tables may be stored along a word line, such that a first state is stored on a first word line, sensing the word line senses all the actions for a first state of the one or more Q tables. In one embodiment, the one or more Q tables are located on a first plane, where the one or more Q tables are alternating. In another embodiment, the one or more Q tables are located on a first plane and on a second plane, where one of the one or more Q tables is located on a first plane and another of the one or more Q tables is located on a second plane. Each state of the one or more Q tables are located on a word line of the plurality of word lines.

At block 610, the calculations to update the Q tables for the current state may be completed by either the controller or the CMOS array, which includes CMOS by the Array, CuA, and CbA. If the controller performs the calculations, then the method 600 advances from block 610 to block 612. However, if the CMOS array performs the calculations, then the method 600 advances from block 610 to block 614.

After completing the calculations at either the controller at block 612 or at the CMOS array at block 614, the method 600 advances to block 616, where the one or more Q tables are updated with the calculated updated Q values from either the controller calculations at block 612 or the CMOS array calculations at block 614. At block 618, the controller determines if the current state completed is the last state in the environment. If the current state is not the last state in the environment, then at block 620, the controller advances the current state to the next state, such as from a first state to a second state. The second state may be on a second word line of one or two planes, such that when sensing the second word line, the one or more Q tables associated with the second state are sensed. After advancing to the next state at block 620, the controller chooses an action according to a given policy at block 606. However, if the current state is the last state at block 618, then at block 622, the method 600 ends.

As noted above, QL is a RL scheme, where an agent learns an optimal decision making policy acting on an environment. The agent learns the optimal actions it should take in each state in episodes acting on the environment. Experience replay buffer is used in QL to improve the training convergence, which becomes extremely slow for large systems with big state and action spaces. Experience replay enables RL agents to memorize and reuse past experiences. Experience replay is the act of storing and replaying game states (the state, action, reward, next_state) that the RL algorithm is able to learn from. Experience replay can be used in off-policy algorithms to learn in an offline fashion. Off-policy methods are able to update the algorithm's parameters using saved and stored information from previously taken actions. A typical QL algorithm without experience replay buffer is:

Q-learning (off policy TD control) for estimating
π ≈ π.

Algorithm parameters: step size α € (0, 1], small ϵ > 0
Initialize Q(s, α), for all s € S⁺, α € [symbol] (s), arbitrarily except
that Q(terminal, .) = 0
Loop for each episode:
Tutialize S
Loop for each step of episode:
Choose A from S using policy derived from Q (e.g., ϵ-greedy)
Take action A, observe R, S'
Q(S, A) ← Q(S, A) + α[R + γ max_{α} Q(S', α) - Q(S, A]
until S is terminal

A typical QL algorithm with experience replay buffer is:

[symbol]

```
Initialize replay memory D to capacity N
Initialize action-value function Q with random weights θ
Initialize target action-value function \hat{Q} with weights θ [symbol]   = θ
For episode = 1, M do
  Initialize sequence s₁ = {x₁} and preprocessed sequence φ₁ = φ(s₁)
  For t = 1, T do
    With probability ε select a random action aₜ
    otherwise select aₜ = argmaxₐQ(φ(sₜ), a; θ)
    Execute action aₜ in emulator and observe reward rₜ and image xₜ₊₁
    Set sₜ₊₁ = sₜ, aₜ, xₜ₊₁ and preprocess φₜ₊₁ = φ(sₜ₊₁)
    Store transition (φₜ, aₜ, rₜ, φ [symbol]  ) in D
    Sample random minibatch of transitions (φⱼ, aⱼ, rⱼ, φⱼ₊₁) from D
    $Set {y}_{j} = \{ \begin{matrix}{r}_{j} & if episode terminates at step j + 1 \\ {r}_{j} + y \text{?} \hat{Q} ( \text{?} ) & otherwise\end{matrix}$
    Perform a gradient descent step on (yⱼ − Q(φⱼ, aⱼ; θ))² with respect to
    the network parameters θ
    Every C steps reset \hat{Q} = Q
  End For
End For [symbol]
indicates data missing or illegible when filed
```

The experience replay buffer stores states Sₜ, actions aₜ, rewards rₜ, and next states

$${S}_{t + 1}^{′}$$

for a plurality of randomly selected states and actions and during the training, a neural network training for example, batches are chosen from the experience replay buffer and the neural network weights are optimized using the QL information stored in the replay buffer B(Sₜ, aₜ, rₜ, S′ₜ₊₁).

The experience replay buffer size is another parameter and it was found that the performance of the converged Q table depends on the experience replay buffer size where too short or too long sizes may give sub-optimal results.

Previous approaches for using QL with an experience replay buffer

$$B ( {S}_{t} , {a}_{t} , {r}_{t} , {S}_{t + 1}^{′} )$$

did not specifically the use of NAND flash memory 2D structure (state and actions) to accelerate the training and the inference performance and did not provide the improved &-greedy scheme proposed here.

Expanding upon the idea is to use not only Q tables, but an additional table on the same word line. Q learning algorithms are discussed above and stored as a Q table in the memory device. The Q table is stored by placing all possibilities for a single state on the same word line. The additional table to be placed on the same word line is called a replay buffer or experience replay buffer which may be referred to as a B table. The B table improves the learning phase as will be discussed below.

The idea is to do the same thing as done with the Q table, but with the B table too. All of the information of the replay buffer (i.e., B table) is placed on the same word line. The width of the word line is very high, so there's no problem to put more information on one word line. Both the Q table and the B table are on the same word line. The Q and B tables are on a word line per state, like the Q table discussed above. For the B table, the controller is not calculating the maximum value as occurs in the Q learning scheme, but instead calculates the minimum value. In a way, the buffer or B table is the opposite of the Q table because the B table and the Q table should converge. The maximum value for the Q table is the right value and hence, right action, to select and for the B table, the minimal value is the right value and hence, right action, to select, and should be the same information as the maximum on the Q table. So while the Q table is maximal, the B table is minimal, and the idea is that during the calculation both the Q table and the B table are updated. Also, when selecting an action, the controller selects from the Q table according to the maximum value or from the B table according to the minimum value. The Q table and the B table are on the same word line.

Because a state for the Q table and the B table are on the same word line, in one sense operation or one read operation of that word line, the controller obtains all of the information of the state for both the Q table and the B table. Thinking of the Q table and the B table as two dimensional tables, the tables have states and actions. For each state, there are many, many actions. One row in the table is the logical equivalent to one word line. One row contains many actions for one state. Stated another way, think of the table as having one state on one row and then along the row there are many, many actions. There are rows and columns and along the columns there are the actions. The Q table is set up with a plurality of states (i.e., the number of rows is equal to the number of states) and a plurality of columns. Within the columns are the actions. Along a single word line in the memory device is: one single state of the Q table along with all of the actions for the one single state of the Q table; and one single state of the B table along with all of the actions for the one single state. Note that the single state for the Q table and the B table is identical.

In regards to the B table, the same reasoning occurs. On the side of the Q table is the B table (also referred to as the B table or buffer table) that has the same structure as the Q table. The B table has the same number of rows and the same number of columns as the Q table. The B table is completely symmetric with the Q table so there is the same number of rows and the same number of columns in both the Q table and the B table. From the Q table the maximum value is obtained, and from the B table the minimum value is obtained. In the columns are the actions that can be selected for each state. So the idea with Q learning is that the column that had the maximum value is the right action. For every state, every word line, look for the maximum value of the Q table and take the action, which is the optimal action. The exact opposite occurs with the B table where for every state, every word line, look for the minimum value in the B table and take the action, which is the optimal action. Depending upon the parameters selected such as thirty percent, fifty percent, or twenty percent for example, the Q table is used or the B table is used. Ultimately, the choice of using the Q table or the B table converges to the state where fifty percent of the time the Q table is used and fifty percent of the time the B table is used. At convergence, it is the same to take the maximal from the Q table or take the minimum from the B table because it is the same operation and the operation provides the same action.

Adding an online experience replay buffer B(Sₜ, aₜ) that stores the calculated QL error term square during each training step and using the minimal error term, mina B(Sₜ, aₜ), in addition to the accumulated values in the Q table, Q (Sₜ, aₜ), accelerates the convergence of the QL scheme. Using just the QL scheme without the B table results in a slow convergence speed with large state and action spaces.

The combined Q table and B table learning scheme may be referred to as QL-minimum error term (QL-MET) scheme using the calculated QL error term square,

$$B ( {S}_{t} , {a}_{t} ) = {( {r}_{t} + Υ {Q}_{max a} ( {S}_{t + 1}^{′} , \text{?} ) - Q ( {S}_{t} , {a}_{t} ) )}^{2} / {Q ( {S}_{t} , {a}_{t} )}^{2} ,$$

$$\text{?} \text{indicates text missing or illegible when filed}$$

since when the QL table converges, the value of QL-MET experience replay buffer for this state will be minimal.

The proposed QL-algorithm with the new MET experience replay buffer B is:

```
Initialize the Q table and the experience replay buffer B.
        For episode = 1, M (do)
          Initialize the sequence with state Sₜ₌₀ randomly.
          For t = 1, T (do)
            Generate two random numbers ε_{rnd}_1 and ε_{rnd}_2 < 1
            If ε_{rnd}_1 > 0.1 select the action with maximal Q value in state Sₜ
aₜ = Q_{max a}(Sₜ, a)
                However, if ε_{rnd}_2 < 0.5, select the action with minimal B value
instead of the above
aₜ = B_{min a}(Sₜ, a)
            else if ε_{rnd}_1 < 0.1 select random action aₜ.
            Perform the selected action aₜ and observe the immediate reward
${r}_{t} and the next state {S}_{t + 1}^{′}$
            $In state {S}_{t + 1}^{′} find the action with maximal Q value ( {Q}_{max a} ( {S}_{t + 1}^{′} , {a}_{*} ) )$
and update Q and B tables as follows.
          $Q ( {S}_{t} , {a}_{t} ) = Q ( {S}_{t} , {a}_{t} ) + α ( {r}_{t} + Υ {Q}_{max a} ( {S}_{t + 1}^{′} , {a}_{*} ) - Q ( {S}_{t} , {a}_{t} ) )$
          $B ( {S}_{t} , {a}_{t} ) = {( {r}_{t} + Υ {Q}_{max a} ( {S}_{t + 1}^{′} , {a}_{*} ) - Q ( {S}_{t} , {a}_{t} ) )}^{2} / {Q ( {S}_{t} , {a}_{t} )}^{2}$
        $Update the state according to the selected action {a}_{t} the next state {S}_{t + 1}^{′}$
        ${S}_{t} = {S}_{t + 1}^{′}$
  End do (t)
End do (M)
```

The action selection algorithm with Python code:

While episode_end == 0 :
epsilon_rnd_1 = np.random.rand(1)
epislon_rnd_s = np.random.rand(1)
if ( epsilon_rnd_1 > epsilon_1 ): action = Q[state10,:].
argmax(axis = 0)
if (epsilon_rnd_2 < epsilon_s): action = B[state10,:].
argmin(axis = 0)
else: action = np.random.randint(0, 6)

In the simulations above ε₁=0.1 and ε₂=0.5 were used, however, other values of ε₁ and ε₂ in the range between 0 to 1 may be used and are in the scope of the proposed invention.

The reason that it works nicely is that the expression for the B value is, in a way, the error term. The Q value equals to the Q value plus a term. What the controller is doing with the B table or the experience replay buffer table is taking the square of error term and dividing it by the Q value square. The controller takes the buffer having the values and each step calculates the Q learning equation, and takes the error term square root divided by the Q value squared and puts the result in the B table. So this is the calculation of the B table and when performing the simulation, the terms are calculated and placed in the memory device in the B table which is aligned and arranged like the Q table.

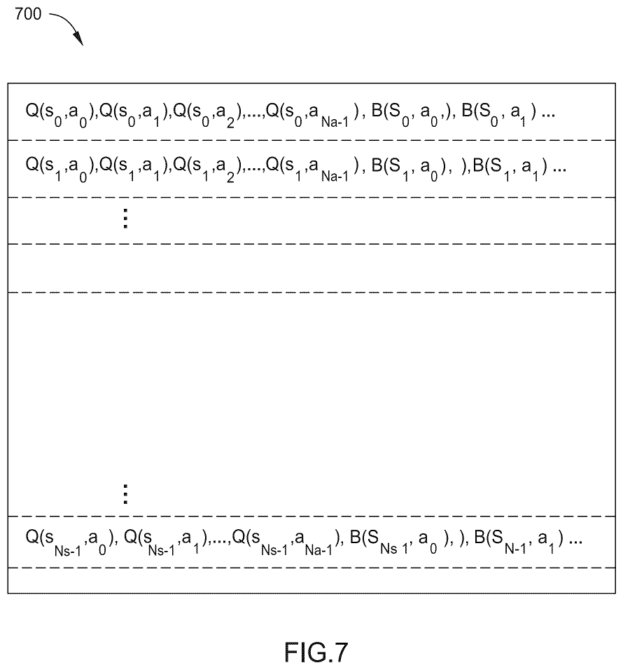

FIG. 7 is a schematic illustration 700 of a Q table and B table arrangement on a page of the non-volatile storage unit, according to one embodiment. FIG. 7 is the pictorial way of looking at the memory in the NAND structure, the Q table and B table. Q (Sₜ, aₜ) is the table arrangement in NAND, Na is the number of actions, Ns is the number of states and B(Sₜ, aₜ) is the new QL-MET experience replay buffer. Since the Q values and QL-MET experience replay buffer per state are stored on a single word line, the proposed training calculation can be done by a single NAND sensing operation of the huge NVM word line also if there are numerous actions per state in each word line for big QL systems. Note also that the calculation of both the maximal value of Q and minimal value of B can be done by HW logic in the NAND.

More specifically, FIG. 7 shows word lines 0-NS−1. Word line 0 has all actions for state 0 for both the Q table and the B table. Word line 1 has all actions for state 1 for both the Q table and the B table. Word line N−1 has all actions for state N−1 for both the Q table and the B table. It is to be understood that additional word lines may be present for additional states. The point of FIG. 7 is to illustrate that a single word line contains a single state. The single state is applicable to both the Q table and the B table. The word line contains all of the actions for the single state for both the Q table and the B table. Hence, sensing the word line 0 (or reading word line 0) results in obtaining all actions for state 0 for both the Q table and the B table. Note that since NAND word line are extremely long, may contain 4, 16, 64, 96 Kilobytes of data and more, a plurality of states with all of their actions per state may be stored on a single word line and that such memory structure is also in the scope of the proposed invention.

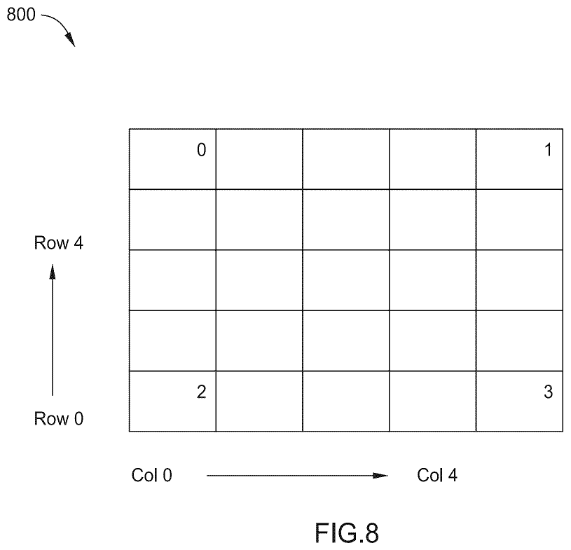

FIG. 8 is a schematic illustration 800 of the QL taxi driver problem. The QL Taxi driver problem has 500 states and 6 possible actions in each state moving on a 5*5 board. Other, larger planes with 6*6, 7*7, 8*8 and 9*9 boards were also tested to increase the state space. The possible 6 actions are: go up (0), go down (1), go right (2), go left (3), pick a passenger from initial station positions (4) and drop a passenger in a destination positions (5). The initial passenger positions and destinations are at the plane four corners and are selected randomly for each training episode. The taxi driver initial position on the board is also selected randomly for each training episode.

If using, for example, just the Q learning without the B table, for each episode the controller calculates the number of steps that it takes to converge. The taxi driver problem is that a taxi driver needs to pick up a passenger from one of the corners. There is 0, 1, 2, and 3 for the four corners. The taxi driver picks up the passenger and then delivers the passenger to any other corner. The taxi driver moves on the board and can move up or down, to the left or right. The taxi driver can start in any place on the plane. So the taxi driver, when performing the selection at each episode, each episode starts with selecting randomly the position of the taxi driver, the position of the passenger and the position the passenger should go. And then the controller, using the Q table, learns the policy, how to take the passenger from the pick-up position to the delivery point in the best way, the fastest way to do it.

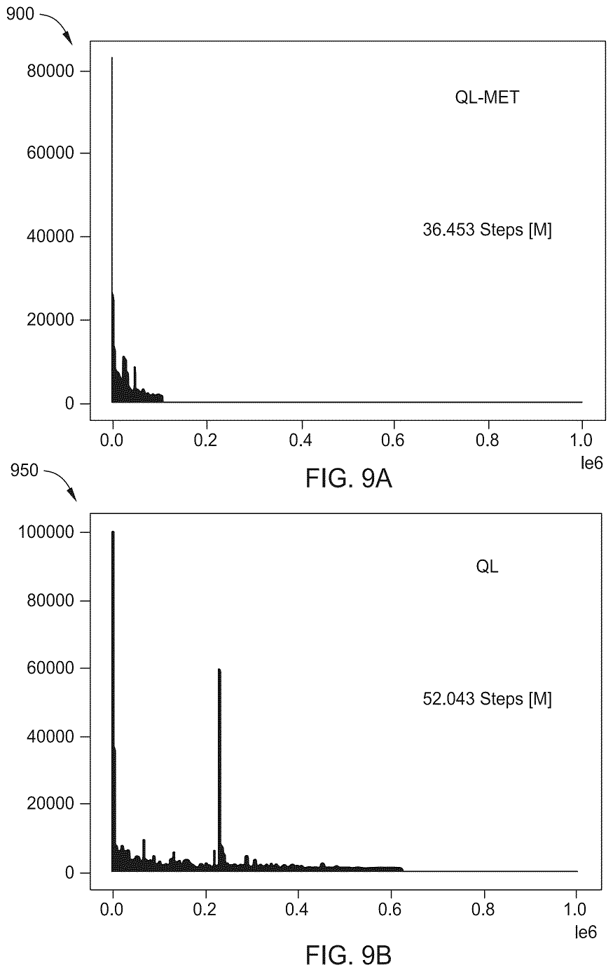

FIGS. 9A (with B table) and 9B (without B table) are graphs 900, 950 illustrating results of the taxi driver problem of FIG. 8. The total number of steps in the training phase of the QL scheme is shown with and without the replay buffer minimal error term selection with an 8*8 taxi driver plane. With the new QL-MET scheme it took about 36 million steps to converge comparing to the QL scheme with about 52 million steps. Thus, the QL-MET (i.e., using Q table and B table on the same word line) converges faster (i.e., about 30 to 40% faster).

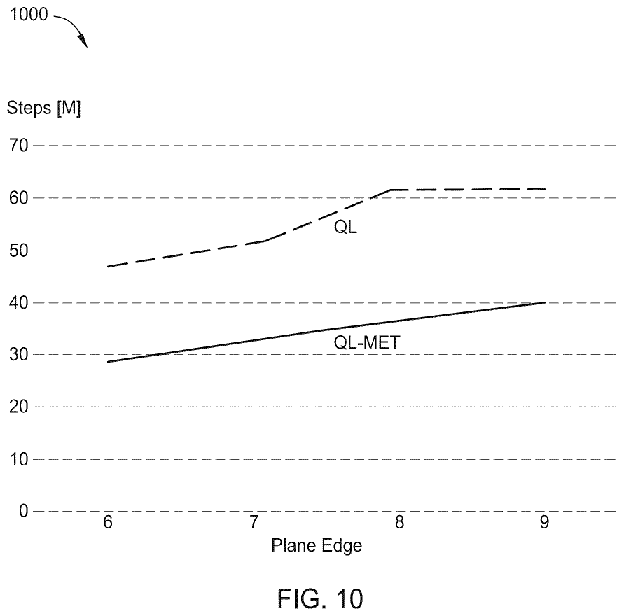

To study the scheme with larger state spaces, calculations can be done with a 6*6, 7*7, 8*8 and 9*9 taxi driver planes with a 1 Million episodes in all calculations. FIG. 10 is a graph 1000 illustrating the plane edge versus steps for the taxi driver problem of FIG. 8. The results show consistently that the proposed QL-MET scheme improves the efficiency of the QL training stage. The improved method converges the Q table faster with smaller total number of steps with all plane sizes. The improvement is by about 35-40%. The reduced total number of steps means shorter computation time for the QL training phase.

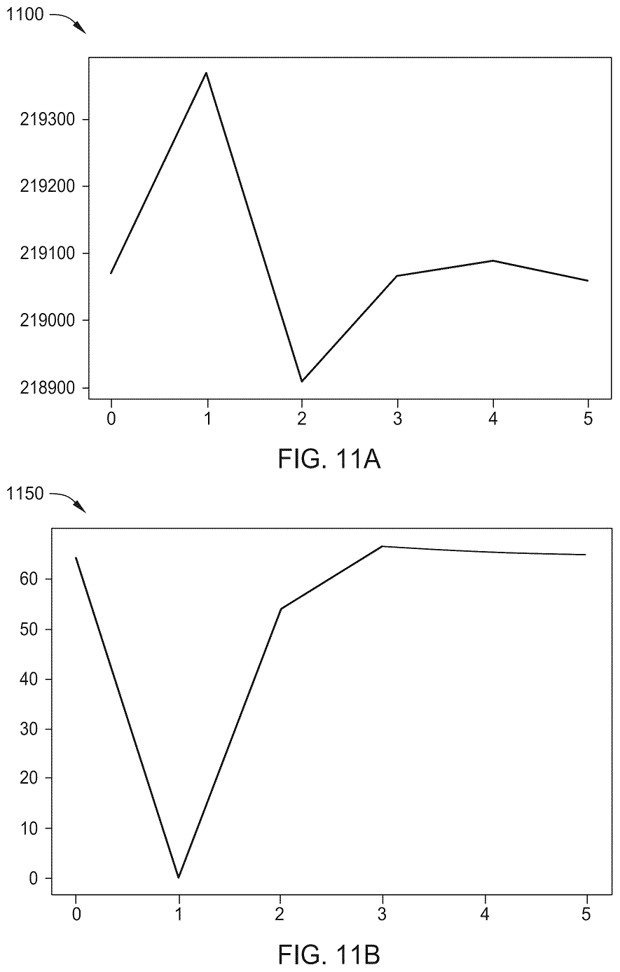

FIGS. 11A and 11B are graphs 1100, 1150 illustrating converged values of the taxi driver problem of FIG. 8 with the converged values of the Q value table and the new experience replay buffer B for a given state. The optimal action in this given state is 1 (go down) as can be seen from the maxima of the Q value and the minimum of the experience replay buffer B is also 1 as shown.

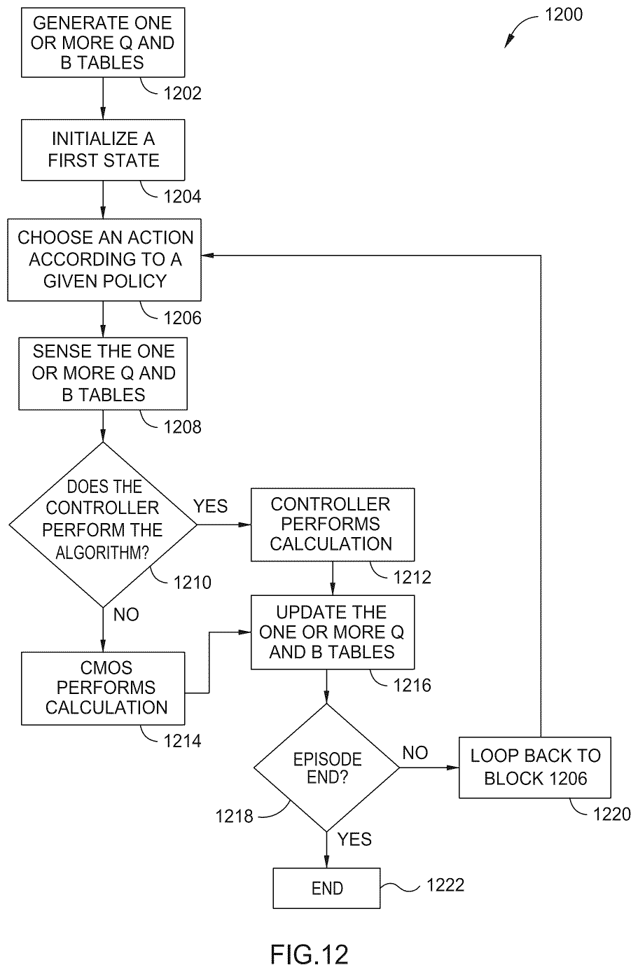

FIG. 12 is a flowchart illustrating a method for performing the reinforcement learning (RL) calculations and updating the B table according to one embodiment. It is to be considered that the B table and the Q table are updated together. At block 1202, the controller, such as the controller 506 of FIG. 5A, or the CMOS array, such as the CMOS 558A-558N described in FIG. 5B, calculates one or more Q table and one or more B table values, where each of the one or more Q tables and one or more B tables includes one or more states and one or more actions for the one or more states. The one or more Q tables and one or more B tables may each have a two dimensional structure that includes a size, a location, and a resolution of each entry.

At block 1204, the controller or the CMOS array starts performing RL training episodes or an inference after convergence of the Q tables and one or more B tables and initializes a first state in a training episode or an inference of the one or more Q tables and one or more B tables after receiving data from a sensor, such as the sensor 502, 552 of FIGS. 5A-5B, for an environment. At block 1206, the controller or the CMOS array chooses an action according to a given policy. At block 1208, the one or more Q tables and one or more B tables stored in the NVM are sensed.

At block 1210, the calculations to update the Q and B tables for the current state may be completed by either the controller or the CMOS array, which includes CMOS under, above or by the Array, CuA, and CbA. If the controller performs the calculations, then the method 1200 advances from block 1210 to block 1212 and the sensed Q and B table values are transferred from the CMOS array on the NAND die to the ASIC controller. However, if the CMOS array on the NAND die performs the calculations, then the method 1200 advances from block 1210 to block 1214.

After completing the calculations at either the controller at block 1212 or at the CMOS array at block 1214, the method 1200 advances to block 1216, where the one or more Q table and one or more B table are updated with the calculated updated Q and B values from either the controller calculations at block 1212 or the CMOS array calculations at block 1214. At block 1218, the controller determines if the episode is completed. If the episode is not completed, then at block 1220, the controller loop back to block 1206 where the next state is selected according to the maximum Q table value or the minimal B table value or randomly according to the given policy. However, if the controller determines that the episode is completed at block 1218, then at block 1222, the method 1200 ends.

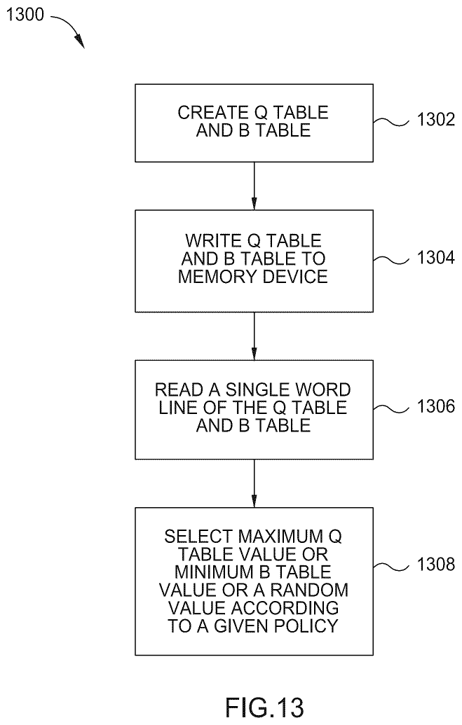

FIG. 13 is a flowchart 1300 illustrating a method for creating and sensing data from a memory device. At block 1302, a Q table and a B table are created with random values, zeros or other fixed values for example. The Q table has a predetermined number of states and a plurality of actions. The B table has the same predetermined number of states and the same plurality of actions. At block 1304, the Q table and the B table are written to the memory device. To perform the writing, a single state or plurality of states of the Q table and the same single state or plurality of states of the B table are written to a word line. The single state is written to the same word line. By writing to the same word line, reading or sensing that single word line will retrieve all actions from both the Q table and the B table for the specific state stored on the word line. At block 1306, the word line is read, and at block 1308, either the maximum value is selected from the Q table or the minimum value is selected from the B table or a random value is selected according to a given policy.

By using the proposed QL-MET scheme, the convergence of QL scheme, which is known to be slow for large state and action space systems, is accelerated. Advantageously, in terms of computation complexity and power consumption, the proposed QL-MET experience replay buffer (i.e., B table) is simple for implementation. The error terms are calculated by the current QL scheme and according to the disclosure are stored in the B table on the fly that has the same size as the Q table and has the same 2D structure that can be read with a single NAND sense operation. In another embodiment, performing the argmax and argmin operations may be done by HW in the NAND close to the NAND array avoiding the transfer time of all the non-used Q and B values per state to the controller.

In one embodiment, a data storage device comprises: a non-volatile memory (NVM) device; and a controller coupled to the NVM device, wherein the controller is configured to: receive Q table and B table data from the NVM device; execute a modified Q-learning model training algorithm to create updated Q table and B table data; and write the updated Q and B tables data in the NVM device, wherein: the B table includes error terms that approach zero for optimal actions when converged. The controller is configured to update the Q table and B table in training episodes until the Q table and B table converge to optimal values, wherein all actions associated with a state of the Q table and B table are stored on the same word line of the NVM device such that reading a word line senses all action values associated with a Q table and B table state. Executing the modified Q-learning model training algorithm to create the updated Q table and B table data comprises executing the following formulas at each state and action:

$$Define {a}_{max}^{*} = arg {max}_{a} Q ( {s}^{′} , a ) ;$$

$$Q ( s , a ) ← Q ( s , a ) + α [ r + γ Q ( {s}^{′} , {a}^{⋆} ) - Q ( s , a ) ] ; and$$

$$Define {a}_{min}^{*} = arg {min}_{a} B ( {s}^{′} , a ) ;$$

$$B ( s , a ) ← {[ r + γ Q ( {s}^{′} , {a}_{max}^{*} ) - Q ( s , a ) ]}^{2} / {Q ( s , a )}^{2} where {a}_{max}^{*}$$

is the optimal action to be taken in a next step according to the Q table and amin is the optimal action to be taken in a next step according to the B table, where a is the action chosen at a current step, where s is a current state, where s′ is a next state, where r is an immediate reward received in the current step, where γ is a discount factor, and where a is a learning rate parameter. Executing the modified Q-learning model training algorithm includes selecting randomly with pre-determined probabilities the actions according to a Q table maximal values, a B table minimal values, and random selections. The pre-determined probabilities are changed dynamically with learning episodes such that a maximal threshold value for selection between the Q table maximal values and the B table minimal values is 0.5, and the maximal value for random selection is 0.1 for example. After convergence of the Q table and B table, optimal actions per state are selected according to a maximal Q value or a minimal B value for each state in an inference stage. The NVM device comprises CMOS by the Array, and wherein executing the modified Q-learning model training algorithm to create the updated Q table and B table data is performed in the CMOS by the Array. The NVM device comprises CMOS under the Array (CuA), and wherein executing the modified Q-learning model training algorithm to create the updated Q table and B table data is performed by the CuA. The NVM device comprises CMOS bounded Array (CbA), and wherein executing the modified Q-learning model training algorithm to create the updated Q table and B table data is performed by the CbA.

In another embodiment, a QL training method comprises: reading Q table and B table data from an NVM device; running a plurality of training episodes, in each episode, selecting in each state an action and accordingly the next state according to the maximal Q table value, the minimal B table value, or a random selection with predefined probabilities; and updating the Q table and B table data in the NVM device, wherein all actions associated with a state of the Q table and B table needed for maximum or minimum calculations are stored on the same word line of the NVM device. Updating the Q table and B table data in the NVM device comprises calculating in each state and selected action the following formulas:

$${a}_{max}^{*} = arg {max}_{a} Q ( {s}^{′} , a ) ; Q ( s , a ) ← Q ( s , a ) + α [ r + γ Q ( {s}^{′} , {a}^{⋆} ) - Q ( s , a ) ] ;$$

$${a}_{min}^{*} = arg {min}_{a} B ( {s}^{′} , a ) ← {[ r + γ Q ( {s}^{′} , {a}_{max}^{*} ) - Q ( s , a ) ]}^{2} / {Q ( s , a )}^{2} .$$

After convergence, optimal actions per state are selected according to a maximal Q value or a minimal B value in each state in an inference stage.

In another embodiment, a data storage device comprises: means to store data; and a controller coupled to the means to store data, wherein the controller is configured to: generate a Q table and a B table, wherein each of the Q table and B table comprises a plurality of states, wherein all actions associated with a state of the Q table and B table are stored on a single word line; sense the single word line of the means to store data, wherein sensing a single word line senses all the data for a single state of the Q table and B table; perform a max argument calculation for the Q table for the state of the single word line; perform a min argument calculation for the B table for the state of the single word line; update the Q table and B table with results of the max and min argument calculations; and advance to the next state. The updating the Q table and B table occurs on the same word line of the means to store data. A structure of the Q table and B table is a two-dimensional structure stored in the means to store data, wherein states are stored in rows of the two-dimensional structure and actions are stored in columns of the two-dimensional structure. In yet another embodiment, performing max and min argument calculations may be performed by a CMOS by the Array. In yet another embodiment, performing max and min argument calculations may be performed by a CMOS under the Array (CuA). In yet another embodiment, performing max and min argument calculations may be performed by a CMOS bounded Array (CbA). The controller is configured to repeat the sensing, the performing, the performing, the updating, and the advancing.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a non-volatile memory (NVM) device; and
a controller coupled to the NVM device, wherein the controller is configured to:
receive Q table and B table data from the NVM device;
execute a modified Q-learning model training algorithm to create updated Q table and B table data; and
write the updated Q table and B table data in the NVM device, wherein the B table includes error terms that approach zero for optimal actions when converged.

2. The data storage device of claim 1, wherein the controller is configured to update the Q table and B table in training episodes until the Q table and B table converge to optimal values.

3. The data storage device of claim 1, wherein all actions associated with a state of the Q table and B table are stored on the same word line of the NVM device such that reading a word line senses all action values associated with a Q table and B table state.

4. The data storage device of claim 3, wherein executing the modified Q-learning model training algorithm to create the updated Q table and B table data comprises executing the following formulas at each state and action:
$$Define {a}_{max}^{*} = arg {max}_{a} Q ( {s}^{′} , a )$$
$$Q ( s , a ) ← Q ( s , a ) + α [ r + γ Q ( {s}^{′} , {a}^{⋆} ) - Q ( s , a ) ] ; and$$
$$Define {a}_{min}^{*} = arg {min}_{a} B ( {s}^{′} , a )$$
$$B ( s , a ) ← {[ r + γ Q ( {s}^{′} , {a}_{max}^{*} ) - Q ( s , a ) ]}^{2} / {Q ( s , a )}^{2}$$
where
$${a}_{max}^{*}$$
is the optimal action to be taken in state s according to the Q table and
$${a}_{min}^{*}$$
is the action chosen at a current step, where s is a current state, where s′ is a next state, where r is an immediate reward received in the current step, where γ is a discount factor, and where a is a learning rate parameter.

5. The data storage device of claim 4, wherein executing the modified Q-learning model training algorithm includes selecting randomly with pre-determined probabilities the actions according to a Q table maximal values, a B table minimal values, and random selections.

6. The data storage device of claim 5, wherein the pre-determined probabilities are changed dynamically with learning episodes such that a maximal threshold value for selection between the Q table maximal values and the B table minimal values is 0.5, and the maximal value for random selection is 0.1.

7. The data storage device of claim 1, wherein after convergence of the Q table and B table, optimal actions per state are selected according to a maximal Q value or a minimal B value for each state in an inference stage.

8. The data storage device of claim 1, wherein the NVM device comprises CMOS by the Array, and wherein executing the modified Q-learning model training algorithm to create the updated Q table and B table data is performed in the CMOS by the Array.

9. The data storage device of claim 1, wherein the NVM device comprises CMOS under the Array (CuA), and wherein executing the modified Q-learning model training algorithm to create the updated Q table and B table data is performed by the CuA.

10. The data storage device of claim 1, wherein the NVM device comprises CMOS bounded Array (CbA), and wherein executing the modified Q-learning model training algorithm to create the updated Q table and B table data is performed by the CbA.

11. A QL model training method, comprising:
reading Q table and B table data from an NVM device;
running a plurality of training episodes, in each episode, selecting in each state an action and accordingly the next state according to the maximal Q table value, the minimal B table value, or a random selection with predefined probabilities; and
updating the Q table and B table data in the NVM device, wherein after convergence, optimal actions per state are selected according to a maximal Q value or a minimal B value in each state in an inference stage.

12. The QL model training method of claim 11, wherein updating the Q table and B table data in the NVM device comprises calculating in each state and selected action the following formulas:
$${a}_{max}^{*} = arg {max}_{a} Q ( {s}^{′} , a )$$
$$Q ( s , a ) ← Q ( s , a ) + α [ r + γ Q ( {s}^{′} , {a}^{⋆} ) - Q ( s , a ) ]$$
$${a}_{min}^{*} = arg {min}_{a} B ( {s}^{′} , a )$$
$$B ( s , a ) ← {[ r + γ Q ( {s}^{′} , {a}_{max}^{*} ) - Q ( s , a ) ]}^{2} / {Q ( s , a )}^{2} .$$

13. The QL model training method of claim 11, wherein after convergence, all actions associated with a state of the Q table and B table needed for maximum or minimum calculations are stored on the same word line of the NVM device.

14. A data storage device, comprising:
means to store data; and
a controller coupled to the means to store data, wherein the controller is configured to:
generate a Q table and a B table, wherein each of the Q table and B table comprises a plurality of states;
sense a single word line of the means to store data, wherein sensing a single word line senses all the data for a single state of the Q table and B table;
perform a max argument calculation for the Q table for the state of the single word line;
perform a min argument calculation for the B table for the state of the single word line;
update the Q table and B table with results of the max and min argument calculations; and
advance to the next state.

15. The data storage device of claim 14, wherein the updating the Q table and B table occurs on the same word line of the means to store data.

16. The data storage device of claim 14, wherein a structure of the Q table and B table is a two-dimensional structure stored in the means to store data, wherein states are stored in rows of the two-dimensional structure and actions are stored in columns of the two-dimensional structure.

17. The data storage device of claim 14, wherein performing max and min argument calculations are performed by a CMOS by the Array.

18. The data storage device of claim 14, wherein performing max and min argument calculations are performed by a CMOS under the Array (CuA).

19. The data storage device of claim 14, wherein performing max and min argument calculations are performed by a CMOS bounded Array (CbA).

20. The data storage device of claim 14, wherein the controller is configured to repeat the sensing, the performing, the performing, the updating, and the advancing.
